(19) United States
(12) Patent Application Publication
(10) Pub. No.: US 2005/0212177 A1
(43) Pub. Date: Sep. 29, 2005

(54) Table and method of manufacturing table

(76) Inventor: Peter P. LaLonde, Hartford, WI (US)

Correspondence Address: RYAN KROMHOLZ & MANION, S.C., POST OFFICE BOX 26618, MILWAUKEE, WI, 53226, US

(21) Appl. No.: 10/806,659

(22) Filed: Mar. 23, 2004

(51) Int. Cl. B28B 3/00

(52) U.S. Cl. 264/333

(57) ABSTRACT

An ornamental table is disclosing having structure such a concrete matrix, an exposed design on a top surface of the matrix, and an insignia on a side surface of the matrix. A method of producing the table is also disclosed.

### BACKGROUND OF THE INVENTION

This invention relates to concrete formed structures and methods for making concrete formed structures.

Many homeowners are using concrete incorporated in functional features of a home such as integral sinks, drainboards, and butcher blocks. Typically, concrete structures such as tables and countertops are either pre-cast in a shop or built on site. Contractors who use pre-cast concrete typically pour the concrete in the shop where conditions are controlled, using special casting tables, and they have the countertop in their possession while it is curing and until it can be adequately sealed.

Concrete structures are made of cement, lightweight aggregates, and a combination of additives. Additives such as fiber reinforcement, silica fume pozzolan, and acrylic are often used.

Some type of reinforcement is used such as structural steel, wire mesh, fiberglass, and/or fibers. Sometimes more than one type of reinforcement is used.

After pouring the concrete and adding the structural support, the concrete structures are cured. Next, countertops are ground, grinding off the surface with progressively finer diamond polishing stones. This achieves two important objectives, durability and beauty.

Next, the concrete structures are sealed. The type of seal, method and number of coats of sealer is unique to each concrete installer. Some installers prefer epoxy sealers, which are preferable harder than the concrete.

### SUMMARY OF THE INVENTION

This invention relates to concrete formed tables and methods for making concrete formed tables. Particularly, utilizing the methods of the present invention, ornamental tables can be produced with intricate inlaid and/or engraved insignia, such as letters, designs, advertising, or other suitably attractive material. Furthermore, utilizing the methods of the present invention, ornamental tables can be produced with highly detailed features on the side surfaces of the tables.

### BRIEF DESCRIPTION OF THE DRAWINGS

FIG. 1 is a perspective view of a mold used in the present invention, the mold bearing an insignia.

FIG. 2 is a top view of the mold, including a design and a jig.

FIG. 3 is a perspective view of a finished structure, incorporating the insignia, the design, a base coupler, and a base.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

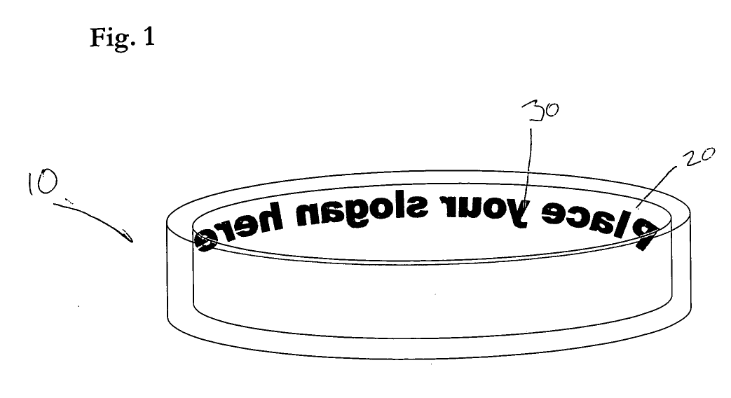

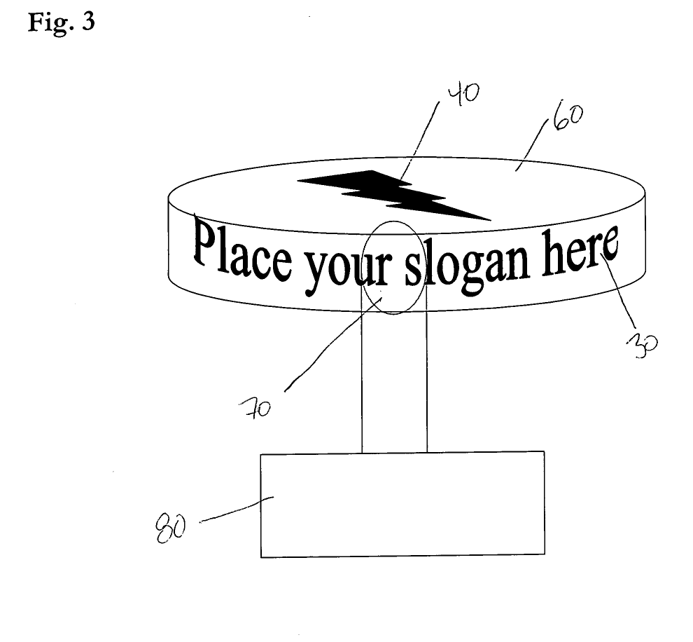

Referring now to FIG. 1, a perspective view of a mold 10 used to produce a table or other structure 60 (shown on FIG. 3) in the present invention is shown, the mold bearing an insignia 30 on an inside wall of the mold 10. The insignia 30 is a mirror image of the desired end product insignia, because the insignia will then be legible outside the mold. It is noted that the insignia 30 is preferably positively formed (i.e., not an indentation in the mold) in order that the insignia in the structure 60 will ultimately appear engraved. However, it is understood that the insignia 30 could also be an indentation in the mold 10, to produce a positive emblem on the structure 60.

Because the insignia 30 can be as detailed as a user desires, it is preferable that a relatively soft molded rubbery material is used to form the mold 10 to both ease eventual withdrawal of the mold 10, yet provide enough rigidity to sustain the detail level of the insignia during curing.

One preferred material for the mold 10 that the inventor has found advantageous is a liquid mold rubber composition, such as polyurethane RTV (or “Room Temperature Vulcanizing”) mold rubber, manufactured by PolyTek Development Corporation of Easton, Pa., who provide flexible high strength rubber for making tough durable molds.

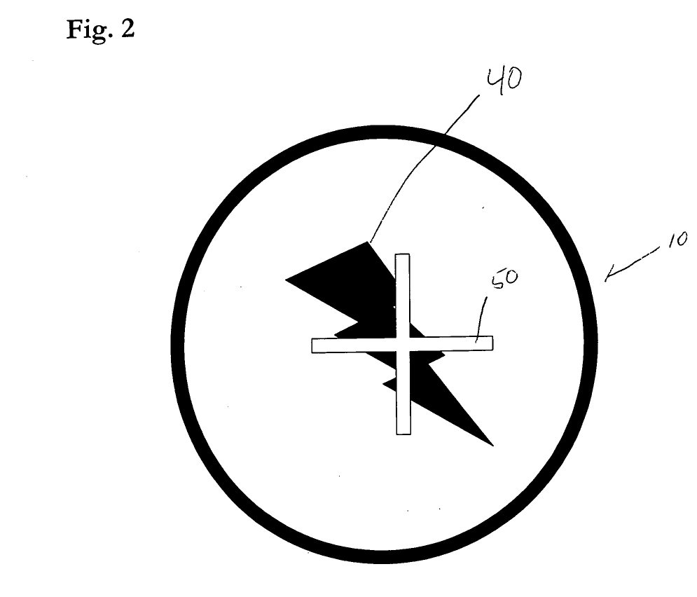

Referring now to FIG. 2, a top view of the mold 10, including a design 40 and a jig 50 is shown.

To manufacture a structure, first the mold 10 is provided. Next, the manufacturer places a design 40, if desired, into the bottom of the mold 10, the bottom filled portion of the mold 10 ultimately becoming the top of the structure 60.

A lightning bolt is shown as a design 40, although the shape, size, color, and composition of the design 40 can vary widely in accordance with user preference. For instance, any type of design, such as a trademark for marketing purposes, can be employed as a design 40, creating an effective marketing tool.

Preferred materials to create the design 40 include, but are not limited to, acrylic, stainless steel, aluminum, brass or the like.

A weighted jig 50 is placed on top of the design 40, such that the design 40 remains on the bottom of the mold 10 when the concretious material is poured into the mold 10. The shape of the jig 50 may vary from that shown. It is preferable that the jig 50 is taller than the mold 10 so that the jig 50 can be removed later in the process, although the jig 50 could remain embedded within the structure 60 if desired. The jig 50 is provided so that the concrete material does not travel under the design 40, so that the design 40 remains apparent to viewers after the mold 10 has been removed (described later).

Next, the manufacturer fills the mold 10 with suitable material (not shown), such as cement, lightweight aggregates, and/or any combination of additives, as fiber reinforcement, silica fume pozzolan, acrylic, coloring materials in accordance with manufacturer preference.

Next, the manufacturer preferably gently vibrates the filled mold 10 (not shown), allowing air bubbles to escape the concretious matrix contained in the mold 10.

Next, the manufacturer can remove the jig 50 from the mold 10 (not shown), and the fill material, because at this point the design 40 will have remained at the bottom of the mold 10.

Next, the manufacturer strikes off, or levels, extra concrete material from the top of the mold 10 (not shown), creating a relatively even surface that will eventually become the bottom of the structure.

Next, the manufacturer can place reinforcement, such as steel, within the concrete matrix (not shown).

Next, the manufacturer again trowels or strikes off, or levels, extra concrete material from the top of the mold 10 (not shown), creating a relatively even surface that will eventually become the bottom of the structure.

Next, the manufacturer inserts a suitable base 70 (shown on FIG. 3), into top of the concrete matrix (that will eventually become the bottom of the structure). The base 70 can vary widely, but one preferable base is a metal structure that is coupled to the concrete matrix by an anchor/bolt system coupled to the base and the matrix. Also preferably, the base 70 will have a threaded coupler for coupling remaining base support, such as support 80 shown on FIG. 3.

Next, the manufacturer allows the concrete matrix to cure, preferably overnight. At this point, the concrete matrix has dried from a wet condition to a “green” condition. At this point, the manufacture can remove the mold 10 from the structure 60.

The structure 60 is then allowed to “rack” or dry for preferably a period of two days, dependent on the type of concrete matrix employed.

At this point in the process, the structure 60 is in a dry condition. Preferably, a slurry is used to fill in any void space that the manufacturer wishes to cover (not shown), and again allowed to sit to allow the slurry to dry.

Preferably, the structure is then polished, such as with a circular sanding device, to remove any of the matrix that may have concealed portions of the design 40.

Next, a coating is applied to the structure 60, and any excess coating is then removed if desired.

As shown in FIG. 3, a finished structure 60 is then produced, with a design 40, an insignia 30, a base 70 and a support structure 80.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A method of making a concrete structure comprising:
providing a mold with a bottom surface and an exposed top;
placing a design on the bottom surface of the mold;
providing a weight atop the design;
filling the mold with a concrete matrix;
allowing the concrete matrix to dry for an initial drying period;
removing the mold from the dried matrix.

2. A method according to claim 1, the method further comprising:
creating an insignia in a sidewall surface of the mold prior to filling said mold.

3. A method according to claim 2, wherein the insignia is a negative impression of a desired insignia.

4. A method according to claim 2, wherein the insignia is a positive impression of a desired insignia.

5. A method according to claim 1, the method further comprising removing said weight prior to allowing the matrix to dry.

6. A method according to claim 1, the method further comprising vibrating said mold prior to allowing the matrix to dry.

7. A method according to claim 1, the method further comprising leveling excess concrete to even with the exposed top prior to allowing the matrix to dry.

8. A method according to claim 1, the method further comprising providing reinforcing steel into the concrete matrix prior to allowing the matrix to dry.

9. A method according to claim 1, the method further comprising coupling a base structure to the concrete matrix prior to allowing the matrix to dry.

10. A method according to claim 9, the method further comprising coupling a support structure to said base structure.

11. A method according to claim 1, the method further comprising allowing an additional drying period following removing the mold from the dried matrix.

12. A method according to claim 11, the method further comprising grinding a top surface of the structure following allowing an additional drying period, thereby exposing the design on the structure.

13. A method according to claim 1, the method further comprising applying a slurry to a surface of the structure, thereby filling undesired void spaces.

14. A method according to claim 13, the method further comprising allowing a second additional drying period following the slurrying step.

15. A method according to claim 1, the method further comprising polishing the structure to a desired finish following said initial drying period.

16. A method according to claim 1, the method further comprising applying a finishing coat of a desired sealant to said structure following said initial drying period.

17. A structure comprising a concrete matrix, an exposed design on a top surface of said matrix, and an insignia on a side surface of said matrix.

18. A structure formed by the method of claim 1.
